(19) United States
(12) Patent Application Publication
(10) Pub. No.: US 2009/0183007 A1
(43) Pub. Date: Jul. 16, 2009

(54) Method, Computer Program Product and Apparatus for Authenticating Electronic Documents

(75) Inventors: Edmond Lim, Richmond Hill (CA); Sherry Shuhua Yang, Thornhill (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Illinois Tools Works Inc.

(21) Appl. No.: 11/972,681

(22) Filed: Jan. 11, 2008

(51) Int. Cl. H04L 9/06

(52) U.S. Cl. 713/176

(57) ABSTRACT

An apparatus for enabling secure control over electronic seals and signatures may include a processing element. The processing element may be configured to select a design drawing file for generation of a corresponding design drawing document, apply a digitized signature and seal and a uniform resource locator (URL) to the design drawing file to generate the design drawing document including the digitized signature and seal and the URL, and store the generated design drawing document at an access-restricted location accessible via the URL, the location being associated with a signer of the digitized signature.

### FIELD OF THE INVENTION

Embodiments of the present invention generally relate to authenticating electronic documents and, more particularly, relate to generating an authentic digitally signed and sealed engineering drawing document from an engineering drawing file.

### BACKGROUND OF THE INVENTION

In certain professional communities, such as the engineering community, it is common for qualified engineers to be licensed by a professional association that may issue a seal to a licensed engineer that meets and maintains certain professional and educational standards. The licensed engineer may then apply the seal and his or her signature to an engineering drawing to signify that the drawing has been reviewed and approved for use. By doing so, the engineer takes professional responsibility for the drawings. Accordingly, given that some projects that impact public safety may be undertaken in reliance upon the competence of the licensed engineer, it is easily appreciated that security with respect to the seal and signature of the engineer are of paramount importance.

Computer aided design (CAD), electronic document formats such as, for example, PDF (portable document format) and associated viewers (e.g., Adobe Acrobat) have enabled designers and engineers to increase their productivity in relation to generation of design or engineering drawings. Furthermore, techniques have been developed that may enable the application of a digitized signature or seal to be applied to an electronic document. Accordingly, it might be possible for anyone with the ability to scan an existing signature and seal to apply the seal and signature indiscriminately or mistakenly to documents under inappropriate circumstances.

Another problem that may be encountered, for example, in the context of engineering drawings, relates to review of the drawings by one or more of customers or third parties. In this regard, for example, one or more of a building department engineer, customer or another entity may be required or desired in a review chain for final approval of a particular plan or drawing. As such, one or more of tracking or adoption of suggested changes by the building department engineer may become complicated. Furthermore, such changes may be made on a previously signed and sealed document thereby necessitating the production of a new signed and sealed document.

As a result, it may be desirable to provide a mechanism by which digitally signed and sealed engineering drawing documents may be authenticated to enable increased engineer productivity, while avoiding a sacrifice in terms of security. Additionally, a mechanism for providing improved access to one or more of reviewing or tracking of changes made during a review process may also be desirable.

### BRIEF SUMMARY OF THE INVENTION

Accordingly, in order to provide a mechanism by which to enable secure control over electronic seal images and signature images, exemplary embodiments of the present invention provide a method, computer program product and apparatus for generating a signed and sealed engineering drawing document from an engineering drawing file securely. Exemplary embodiments may further provide a mechanism for enabling one or more of the insertion, tracking or review of changes made with respect to a particular engineering drawing document.

In one exemplary embodiment, a method is provided for enabling secure control over electronic seals and signatures. The method may include applying a digitized signature and seal and a uniform resource identifier (URI) or uniform resource locator (URL) to a design drawing file to generate a design drawing document including the digitized signature and seal and the URL, and storing the generated design drawing document at an access restricted location accessible via the URL. The location is associated with a signer of the digitized signature.

In another exemplary embodiment, a computer program product is provided for enabling secure control over electronic seals and signatures. The computer program product includes at least one computer-readable storage medium having computer-readable program code portions stored therein. The computer-readable program code includes multiple executable portions. The first executable portion may be for applying a digitized signature and seal and a URL to the design drawing file to generate the design drawing document including the digitized signature and seal and the URL. The second executable portion may be for storing the generated design drawing document at an access restricted location accessible via the URL. The location is associated with a signer of the digitized signature.

In yet another exemplary embodiment, an apparatus is provided for enabling secure control over electronic seals and signatures. The apparatus may include a processing element. The processing element may be configured to apply a digitized signature and seal and a URL to a design drawing file to generate a design drawing document including the digitized signature and seal and the URL, and store the generated design drawing document at an access restricted location accessible via the URL. The location is associated with a signer of the digitized signature.

Exemplary embodiments of the invention enable securely applying a digitized signature and a digitized seal to an electronic document in a manner that may permit authentication of the document. Exemplary embodiments may also enable an individual to visually compare an engineering drawing to requested changes that have been submitted and to access a history of transactions made in relation to the engineering drawing. Accordingly, for example, both security with respect to the application of electronic signatures and seals and productivity of engineers may be improved.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system that may benefit from exemplary embodiments of the present invention;

FIG. 2 illustrates a basic block diagram of a terminal enabling secure control over electronic seals and signatures according to an exemplary embodiment of the present invention;

FIG. 3 illustrates a block diagram providing an exemplary work flow for an enhanced design reviewing solution according to an exemplary embodiment of the present invention;

FIG. 4 is a flowchart including various operations of a method of securely controlling over electronic seals and signatures according to one exemplary embodiment of the present invention; and

FIGS. 5-15 illustrate various screenshots or examples of user interface displays and options that may be encountered in an authentication website operating in accordance with an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. Furthermore, as used herein “or” may be interpreted as a logical operator that results in true whenever one or more of its operands are true.

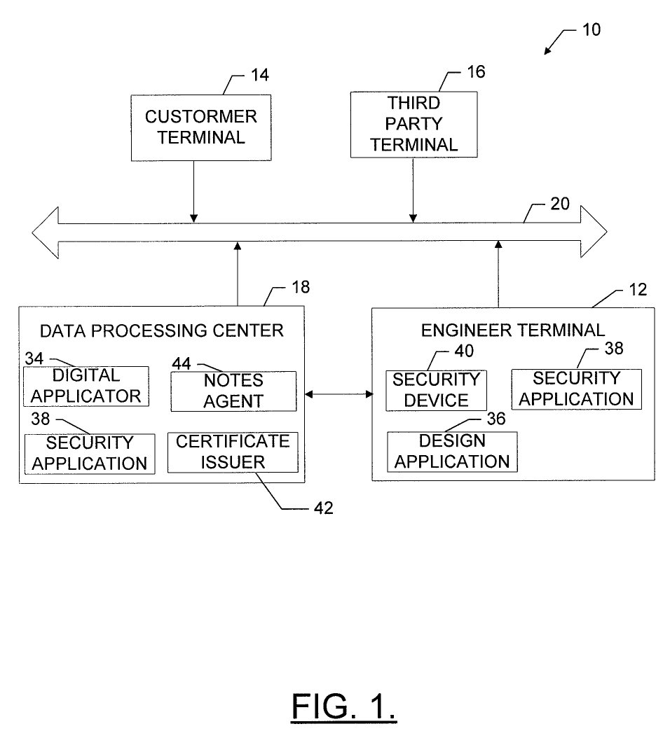

FIG. 1 is a basic block diagram illustrating a system 10 that may benefit from exemplary embodiments of the present invention. As shown and described herein, the system 10 could be employed in the context of a network 20 over which numerous electronic devices may communicate via wired, wireless or a combination of wired and wireless communication mechanisms. In an exemplary embodiment, the electronic devices may be embodied as personal computers (PCs) or other terminals that may enable individuals to run applications or communicate with each other in accordance with embodiments of the present invention. In this regard, the system 10 may include a number of different communication terminals, each of which may comprise any device or means embodied in either hardware, software, or a combination of hardware and software configured to perform one or more functions, including those attributed to the respective terminals as described herein. For example, the system 10 may include an engineer terminal 12 and possibly also numerous other peripheral devices or modules in communication with each other via the network 20. In this regard, for example, an information server or data processing center 18 may also be in communication with the engineer terminal 12 via the network 20. However, it should be noted that some portions of the data processing center 18 could also be collocated with or even a portion of the engineer terminal 12. Other devices that may be in communication with the network 20 may include one or more of a customer terminal 14 or at least one third party terminal 16. The network 20 may be any of a number of different communication backbones or frameworks including, for example, the Internet, a local area network (LAN), an Intranet such as a personal area network (PAN), a campus area network (CAN), a metropolitan area network (MAN), or the like. In one exemplary embodiment, the engineer terminal 12 and the data processing center 18 could be part of a LAN or other localized network (e.g., associated with a particular company) and one or both of the engineer terminal 12 and the data processing center 18 may be in communication with the network 20 either directly or via a gateway device of the LAN.

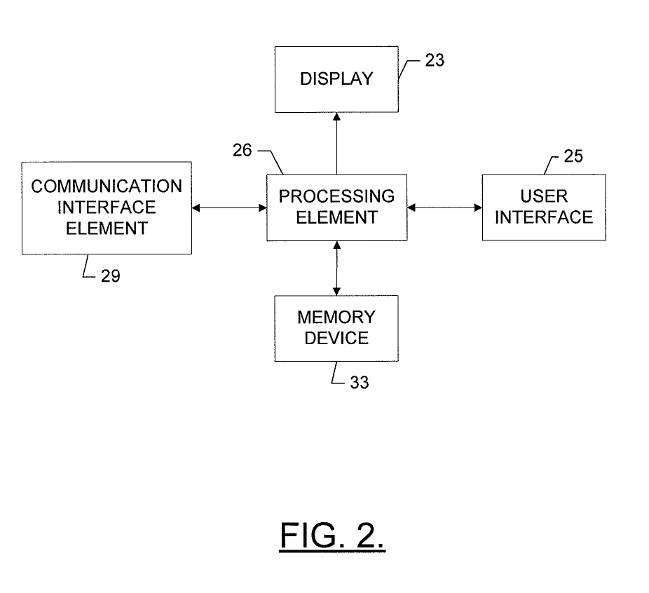

FIG. 2 illustrates a basic block diagram of a terminal (e.g., engineer terminal 12, customer terminal 14, third party terminal 16, etc.) according to an exemplary embodiment of the present invention. It should be understood, however, that a terminal as illustrated and hereinafter described is merely illustrative of one type of electronic device that may benefit from embodiments of the present invention and, therefore, should not be taken to limit the scope of embodiments of the present invention. Moreover, while FIG. 2 illustrates one example of a configuration of a terminal, numerous other configurations may also be used to implement embodiments of the present invention. As such, it should be noted that the devices or elements described below may not be mandatory and thus some may be omitted in certain embodiments. In this regard, for example, the terminal of FIG. 2 may also be representative of a server device (e.g., the data processing center 18) except that the server device may lack one or more of a display or user interface.

In an exemplary embodiment, each of the terminals described above (e.g., the engineer terminal 12, the customer terminal 14, and the third party terminal 16) may include a display 23 configured to display images, and a user interface 25 configured to receive an input from a user of the a corresponding one of the terminals. The display 23 may be, for example, a conventional LCD (liquid crystal display), a cathode ray tube display (CRT), or any other suitable display known in the art. And the user interface 25 may include, for example, one or more of a keyboard, keypad, function keys, mouse, scrolling device, touch screen or any other mechanism by which a user may interface with the corresponding terminal. The terms engineer, customer, and third party are used herein for exemplary purposes to associate each terminal with a corresponding entity for purposes of ease of explanation with regard to one exemplary embodiment. However, these terms should not be considered limiting. In this regard, for example, the engineer terminal 12 could be any terminal, but the term “engineer” merely refers to an entity associated with the terminal in one exemplary embodiment.

As indicated above, the terminals may be configured to receive data via the network 20, and process or display the received data or other data. As shown, in addition to a display 23 and user interface 25, the terminals may include a processing element 26, communication interface element 29 and memory device 33. The memory device 33 may include, for example, one or more of volatile or non-volatile memory. The memory device 33 may be configured to store information, data, applications, instructions or the like for enabling the terminal to carry out various functions in accordance with exemplary embodiments of the present invention. For example, the memory device 33 could be configured to buffer input data for processing by the processing element 26. Additionally or alternatively, the memory device 33 could be configured to store other data including, for example, an application for enabling the manipulation of one or more of engineering drawings or an application for enabling secure control over electronic seals and signatures.

The processing element 26 may be embodied in a number of different ways. For example, the processing element 26 may be embodied as a processor, a coprocessor, a controller or various other processing means or devices including integrated circuits such as, for example, an ASIC (application specific integrated circuit) or an FPGA (field programmable gate array). In an exemplary embodiment, the processing element 26 may be configured to execute instructions stored in the memory device 33 or otherwise accessible to the processing element 26. Meanwhile, the communication interface element 29 may be embodied as any device or means embodied in either hardware, software, or a combination of hardware and software that is configured to receive or transmit data from or to the network 20 or any other device or module in communication with the terminal.

The data processing center 18 may be a server or other computing platform including memory and processing capability (e.g., the memory device 33 and the processing element 26) and in communication with the network 20 in order to facilitate operation in accordance with embodiments of the present invention. In some embodiments, the data processing center 18 may host an authentication website providing access to one or more of the functionalities, devices or elements described below in connection with the data processing center 18.

In an exemplary embodiment, the engineer terminal 12 may be utilized to prepare, modify, review, manage, approve or otherwise interface with design drawings (e.g., engineering drawings) which may be stored as corresponding design drawing files. As such, a design drawing may be created at the engineer terminal 12, for example, by a licensed professional engineer associated with the engineer terminal 12 and stored as a corresponding design drawing file. However, alternatively, the design drawing may be created by another entity such as, for example, a designer or fabricator associated with the third party terminal 16. As yet another alternative, the design drawing file could be downloaded from another source (e.g., via the Internet). The design drawing file could be stored at the memory device 33 of any one or more of the terminals or the data processing center 18 along with other design drawing files. The design drawing file, which may be stored, for example, in a PDF format or a local/proprietary format associated with an application used to create the design drawing file, may be shared electronically among various parties via the network 20. The other parties may be able to view the design drawing file via a viewer application that corresponds to the format of the design drawing file (e.g., Adobe Acrobat for PDF files).

As discussed above, when a particular licensed professional engineer (hereinafter “engineer”) signs and seals the drawing associated with the design drawing file, the drawing may be relied upon by others as being approved for use by the engineer. The seal applied may be a seal bestowed upon the engineer by a professional association that has certified that the engineer has met applicable standards and is a member of the association in good standing. Accordingly, by signing and sealing the drawing, the engineer may take professional responsibility for the contents of the drawing. As such, although the design drawing file could be shared electronically via the network 20 (e.g., between one or more of the engineer terminal 12, the customer terminal 14 or one or more third party terminals 16), the drawing could not be relied upon unless the drawing is signed and sealed by the engineer.

Embodiments of the present invention provide security measures that enable the engineer (or other approval authority) to electronically sign and seal the drawing to review drawings and thereafter create a design drawing document having the signature and seal of the signer/sealer of the document (e.g., the engineer). Furthermore, embodiments of the present invention provide a mechanism by which the design drawing document may be authenticated by other parties to ensure that a particular design drawing document is authentic. Some embodiments further enable modification or change requests, or the changes themselves, to be tracked by individuals accessing the design drawing document.

The engineer terminal 12 may be a terminal associated with a particular engineer or a business enterprise employing or otherwise affiliated with the particular engineer. The customer terminal 14 and the third party terminal 16 may each be terminals associated with a customer or other third party, respectively, which may include public or proprietary software to enable viewing of documents produced in accordance with embodiments of the present invention. Embodiments of the present invention may enable an engineer to generate a design drawing document having a digitally applied signature and seal associated with the engineer from a design drawing file. In this regard, the engineering terminal 12 may include or otherwise be in communication with one or more of a digital applicator 34 or a design application 36.

The digital applicator 34 may be any means such as a device or circuitry embodied in hardware, software, or a combination of hardware and software that is configured to apply an electronic signature and seal in accordance with exemplary embodiments of the present invention as described in greater detail below. The digital applicator 34 may operate under the control of (or even be embodied as) the processing element 26. In some embodiments, such as the embodiment shown in FIG. 1, the digital applicator 34 may be embodied in software at the data processing center 18. As such, the engineer terminal 12 may communicate with the digital applicator 34 in a client/server environment in order to access electronic signature and seal services from the data processing center 18 for the generation of the design drawing document from the design drawing file.

The design application 36 may be any means such as a device or circuitry embodied in hardware, software, or a combination of hardware and software that is configured to enable drawing creation, review, editing and, in combination with the digital applicator 34, electronic signing and sealing of documents. The design application 36 may be, for example, public or proprietary software for enhancing work flow with regard to engineering or design drawings. In an exemplary embodiment, the design application 36 may be configured to present a display of a particular drawing associated with a design drawing file. The design application 36 may also provide the engineer (e.g., via the user interface 25 and display 23) with an ability to provide the design application 36 with commands or instructions related to one or more of creation, review, editing or electronic signing and sealing of documents. In this regard, for example, the design application 36 may provide a user interface or control console including commands or functions which, when selected by the engineer, may be performed with respect to the particular drawing. In some embodiments, the user interface or control console functions may be presented when a particular drawing is displayed. However, other functions (e.g., selection of a particular drawing, selection of a job, creation of a job, or the like) may be performed in the absence of a display of any particular drawing.

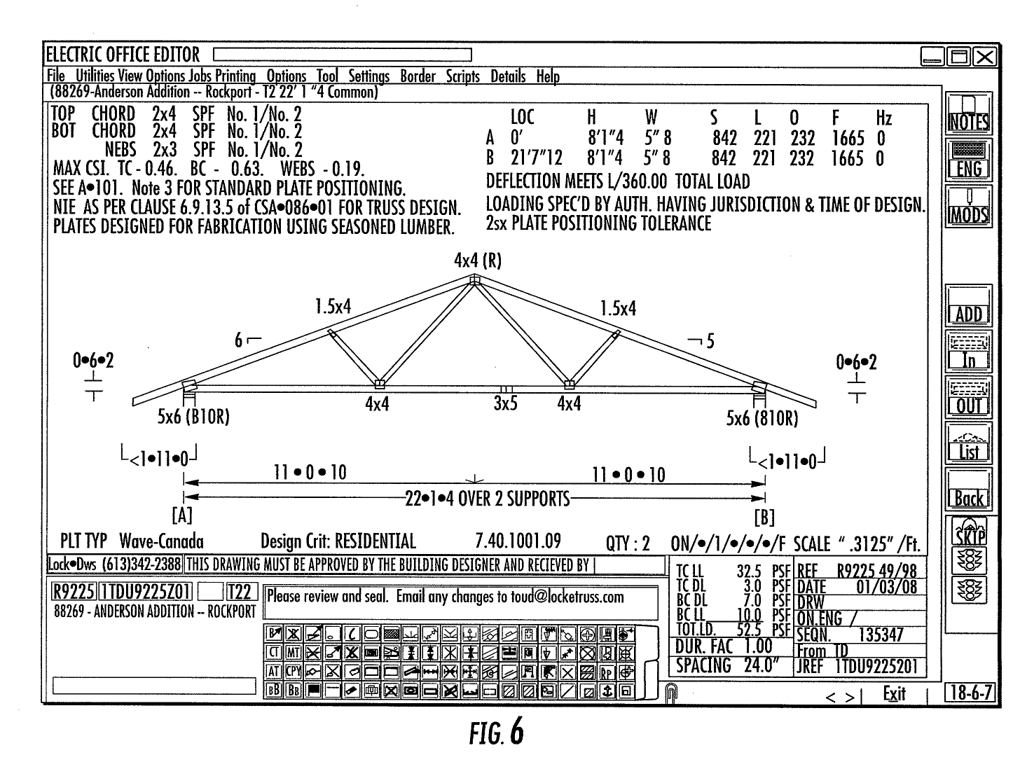

One function that may be selected in association with a design drawing file may be to generate a design drawing document having the signature and seal of the engineer thereon. In other words, one function may be to enable the engineer to approve a drawing or drawings. Accordingly, for a selected drawing (e.g., a drawing currently displayed), a particular option may be selected from the user interface or control console to cause the digital applicator 34 to apply an electronic seal and signature to the corresponding design drawing file to generate the respective design drawing document. When the engineer instructs the application of the electronic seal and signature (e.g., via selection of a function key such as a “greenlight” function of FIG. 6), the digital applicator 34 may, for example, retrieve a digitized image of a seal and signature associated with the engineer and create a printable document (e.g., in a PDF format) comprising the design drawing document having the corresponding drawing images along with the seal and signature of the engineer. A current date stamp may also be applied to the design drawing document along with the seal and signature. According to exemplary embodiments, after the seal and signature are applied to create the printable document, the seal and signature are removed from the design drawing file itself, so that the design drawing file never has the seal and signature images stored with the design drawing file itself. Meanwhile, the design drawing document includes the digitized image of the seal and signature of the engineer thereby indicating that the engineer has taken professional responsibility for the document. In an exemplary embodiment, the seal, signature, and date stamp may all be applied independently of one another, for example, within a predefined zone to provide a unique aspect with regard to each and every application of seals and signatures by the digital applicator 34.

In an exemplary embodiment, to further provide for authentication of the design drawing document, the digital applicator 34 may also apply a location identifier indicative of a storage location of the design drawing document. For example, a uniform resource locator (URL) may be provided along with the drawing in the design drawing document. The URL may be linked to or point to a document at an access restricted location (e.g., an access restricted web site or web page). The access restricted location may be associated with the signer/sealer of the document (e.g., the engineer). Accordingly, for example, if a third party or customer is reviewing the design drawing document online, the third party or customer can verify the authenticity of the design drawing document by clicking or selecting the URL on the document. The third party or customer may then be linked to a web site or web page including the storage location of the design drawing document and be enabled to verify whether the design drawing document is indeed authentic. Alternatively, if the third party or customer is in receipt of or otherwise aware of a paper copy of the design drawing document, the third party or customer may type the URL from the paper copy into a web browser in order to access the design drawing document for authentication purposes.

In some embodiments, one or more drawings may be associated with a particular design drawing file. As such, for example, a plurality of drawings may be associated with a particular file, which may be identified or otherwise associated with a particular job, job number or job title. Accordingly, for example, the engineer may select a plurality of drawings to be included in a particular job, such that the job (and the corresponding file) may be accessed to retrieve all the associated drawings with a single retrieval operation. Similarly, after all the drawings for a particular job have been reviewed by the engineer using the design application 36 and the engineer is ready to take professional responsibility for the drawings, the engineer may select an option (e.g., via the design application 36) to approve the drawings associated with the particular job. The digital applicator 34 may then be engaged to apply the seal and signature along with the date stamp and URL to create the design drawing document. The design drawing document may then be stored at a location corresponding to the URL. When a document is accessed at the URL, the accessed document cannot be altered, except by the engineer (e.g., after clearing security or proper identification) or as further provided below. Moreover, if the engineer changes a drawing and selects the drawing for approval, a new signature and sealing operation may be performed and a new document with a new signature, seal and date stamp may be generated. The new document may then replace the old document at the corresponding URL. A history of the change may also be recorded and may be accessible when the URL is accessed.

In order to ensure security with regard to the granting of access to electronic signature and sealing application, one or more of the engineer terminal 12 or the data processing center 18 may include a security application 38, which may be any means such as a device or circuitry embodied in hardware, software, or a combination of hardware and software that is configured to provide authentication services to ensure the identity of the engineer prior to enabling the engineer to access services of the digital applicator 34. The security application 38 may, for example, require the engineer to login by providing a username or other identification and a corresponding password or code. In this regard, the security application 38 may provide for the maintenance of separate accounts or records associated with each engineer. Each account may include a digitized or other displayable or printable image of a seal associated with the engineer and one or more signatures of the engineer. For example, the memory device 33 may store a plurality of accounts and corresponding seal and signature images. Accordingly, for example, although a particular organization may employ many engineers, the signature and seal of each of the engineers may be separately stored and secured in association with each respective engineer.

In an exemplary embodiment, the engineer terminal 12 (or another terminal) may further include other peripherals or devices. For example, as further illustrated in FIG. 1, the engineer terminal 12 may include a security device 40. In an exemplary embodiment, the security device 40 may be any means such as a device or circuitry embodied in hardware, software, or a combination of hardware and software that is configured to provide an additional layer of security for the purpose of identifying a particular engineer. In some embodiments, the security device 40 may be one or more of a magnetic card reader, a radio frequency identification (RFID) reader, a biometric identification device, smart card, or the like. Accordingly, a magnetic card, RFID tag or merely physiological or behavioral traits associated with the particular engineer may be used to assist in identifying and authenticating the particular engineer prior to granting the particular engineer access to the services of the digital applicator 34.

Accordingly, some embodiments may include at least two security levels for access to signature and sealing functions. Thus, for example, in order for the engineer to sign and seal a drawing, the engineer may be required to provide a login and password to pass a security check by the security application 38 and provide further evidence of identity in relation to possession of a key, access card (e.g., magnetic, RFID, etc.), or other indicia of identity to pass a security check by the security device 40. As described in greater detail below, still further security may also be provided.

In this regard, for example, in order to enforce the integrity, confidentiality and authenticity of a design drawing with electronic signatures and digitized seals, a certificate issuer 42 may also be provided (e.g., at the data processing center 18). The certificate issuer 42 may be any means such as a device or circuitry embodied in hardware, software, or a combination of hardware and software that is configured to provide a certification of the seal and signature applied by the digital applicator 34. In an exemplary embodiment, the certificate issuer 42 may act as an intermediate Certificate Authority to certify digital seals and signatures. In this regard, for example, the certificate issuer 42 may utilize a cryptographic protocol (e.g., secure sockets layer (SSL) or public key infrastructure (PKI)) and issue a certificate to accompany any seal and signature applied by the digital applicator 34. The certificate issued by the certificate issuer 42 may be used to further verify the authenticity of the seal and signature to provide document integrity for the design drawing document. Furthermore, in an exemplary embodiment, the certificate issuer 42 may be enabled to request a certificate from an outside agency to include instead of or in addition to the certificate otherwise issued by the certificate issuer 42. In this regard, for example, if a professional agency or other certifying agency provides a particular static certificate to illustrate that a particular electronic seal and signature is authentic, the certificate issuer 42 may communicate with an entity at the professional agency for inclusion in the design drawing document as further evidence of the authenticity of the signature and seal thereon and as evidence that requirements of the professional agency or outside agency have also been met.

In some embodiments, in addition to enabling customers or third parties to view drawings, one or more of the customer terminal 14 or the third party terminal 16 may run public or proprietary software that enables other entities such as the customer or third parties to make comments and edit or change requests on one or more of the drawings associated with a particular job. In this regard, for example, if a fabricator has produced a drawing, then a building department engineer may wish to make notes on the drawing or request specific edits or changes (e.g., FIG. 6 illustrates user interface function keys to enable to provision of notes). Such a process may typically take days using conventional means as hard copies of the drawing are exchanged with handwritten notes associated therewith. Embodiments of the present invention may enable the building department engineer (or other interested parties) to review documents or approve or request edits or changes to the documents electronically so that other parties may electronically receive the documents and make their own approval, edit requests or changes to the documents as well. Since the process can be done electronically, the review process may be shortened.

In order to implement a mechanism for an enhanced design reviewing solution, embodiments of the present invention may further employ a notes agent 44. In some embodiments, a notes agent may be embodied on each of the terminals. However, alternatively, a single notes agent may be embodied at the data processing center 18 and services associated therewith may be provided to the terminals via a client/server relationship in which the terminals act as clients with respect to the data processing center 18. The notes agent 44 may be any means such as a device or circuitry embodied in hardware, software, or a combination of hardware and software that is configured to provide services and facilitate document exchange among jobs and comments in the data processing center 18 and terminals, including the engineer terminal 12, the customer terminal 14 or the third party terminal 16. In this regard, in an exemplary embodiment, the notes agent 44 may also enable a terminal to provide notes or provide access to review of notes posted by other parties with respect to a particular design drawing file. As such, a design drawing file, or series of files, which may be associated with a particular job, may be accessed by interested (or authorized) parties and comments may be associated with the particular job (e.g., as a whole or on a drawing by drawing basis) for review by other parties.

In an exemplary embodiment, a version of the security application 38 may also be employed at one or more of the customer terminal 14 or the third party terminal 16 in order to permit access to the notes agent 44. When a customer (e.g., the fabricator) or engineer logs in and selects a particular job, the design drawing file or files associated with the particular job may be retrieved. One or more of the customer or engineer may be enabled (e.g., via a user interface and control console) to toggle through the drawings associated with the particular job. The notes agent 44 may provide an overlay to the design drawing file onto which the comments, edits or suggestions of the customer may be provided. In some embodiments each party that has clearance to review the particular job may have a corresponding layer that is associated with the party. Thus, for example, if there is a customer, a third party, and an engineer associated with a particular job, there may be one or more of a customer overlay, a third party overlay or an engineer overlay. As an alternative, there may be a single overlay onto which all comments, etc., are made.

Changes or comments in the overlay may be distinguished from the underlying document by various mechanisms. For example, comments or changes in the overlay may be color coded. In this regard, each overlay may be associated with a separate color. Alternatively, comments may have one color and edits or change requests may have another color. Shading, highlighting, font differences, author or editor name and time stamp, and other mechanisms may also be used to distinguish changes or comments in an overlay from a base document. In an exemplary embodiment, layers may be selected for inclusion or exclusion so that changes to the base drawing may more easily be determined or tracked.

Approval may also be indicated in the overlay. In this regard, in some instances in which the approval of multiple approval authorities may be desirable prior to final approval by the engineer, it may be possible to further place one or more of seal or approval information that may be stored for other parties (e.g., other approval authorities) on the design drawing document if the corresponding approval authority's approval is indicated on the overlay. As such, the data processing center 18 may further store one or more of seal or approval stamp images associated with respective other approval authorities, which may be applied to documents that have been finally approved.

In an exemplary embodiment, when a document is accessed at the URL, information may be provided that is indicative of the change or comment history associated with the document. Thus, for example, a customer, reviewing engineer or third party may determine when changes were made or requested for the document and by whom the changes were requested. Accordingly, for a particular document having a seal and signature, an individual accessing the URL can quickly determine whether changes were made since the issuance of the seal and signature based on comparing the date stamp on the document to the document history. Accordingly, the integrity of drawings may be maintained using the URL. The document history may be indicated along with design drawing files or may be accessible via a separate menu option.

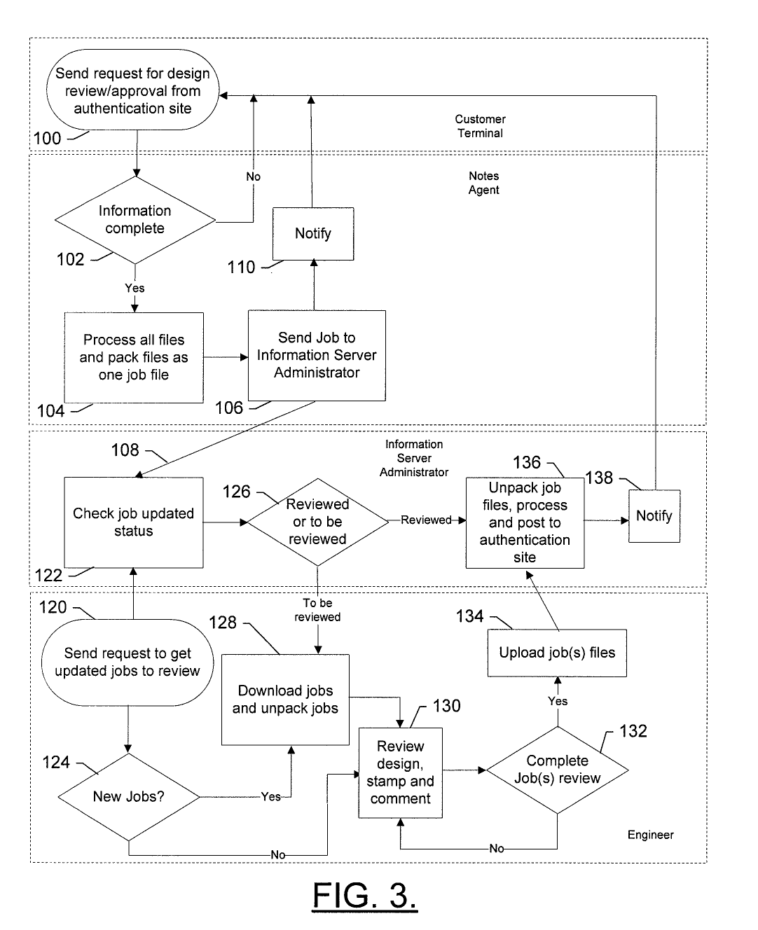

FIG. 3 illustrates a block diagram providing an exemplary work flow for an enhanced design reviewing solution according to an exemplary embodiment of the present invention. Of note, FIG. 3 is illustrative of one exemplary embodiment and therefore additional operations may be performed or some operations may be omitted in some alternative embodiments. Referring now to FIG. 3, workflow may begin at operation 100 or operation 120. In this regard, at operation 100, the customer may send a request for design review/approval from an authentication site (e.g., hosted by the data processing center 18). The request may be made in the form of a request document that may include one or more design drawing files. The files may be uploaded from the customer terminal 14 for inclusion in the request. In an exemplary embodiment, the uploaded files may include comments, edits, change requests, etc., in an overlay provided with an original drawing or drawings. Accordingly, the design drawing files uploaded by the customer may include a drawing (e.g., in a PDF format) and a separate overlay provided over the drawing.

The notes agent 44 may be triggered by submission of the request in order to verify whether the request is complete (e.g., identifies a valid job number, includes design drawing files, etc.) at operation 102. If the request is not complete the notes agent 44 may return the request to the customer for completion. Meanwhile, if the request is complete, files may be processed and packed into a corresponding job file at operation 104. The job file may then be sent to the data processing center 18 at operation 106 where an administrator application may track a job update status for the job at operation 108. The notes agent 44 may also notify the customer that the job has been sent at operation 110.

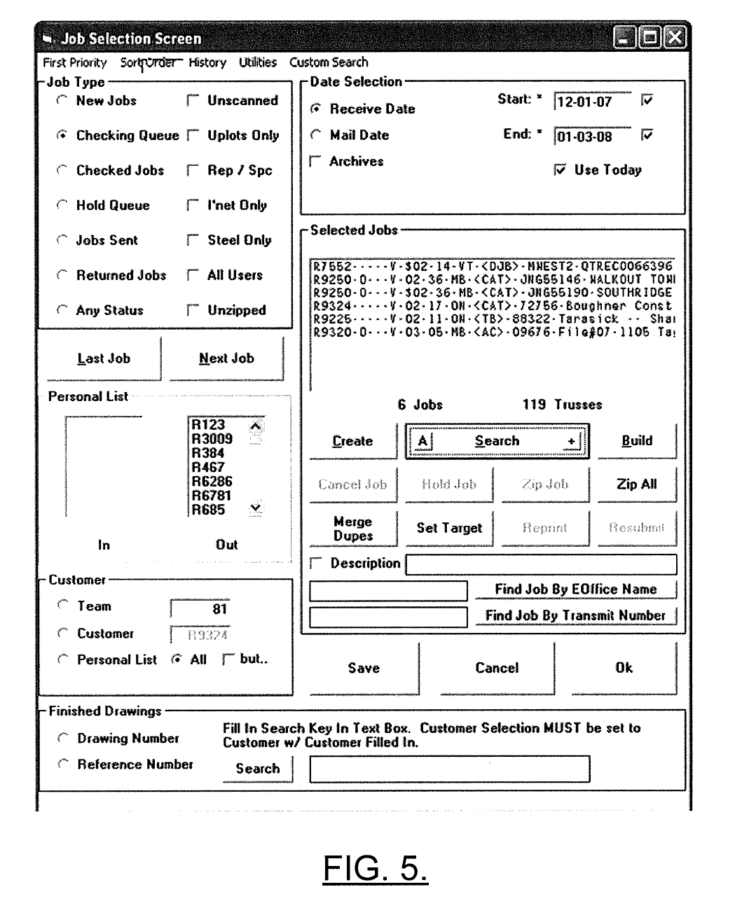

At operation 120, the engineer may send a request to get updated jobs for review. The request may trigger a check of jobs in the system at the data processing center 18 to determine if any jobs indicate an updated status at operation 122. Updated jobs may then be checked to determine whether they are already reviewed or need to be reviewed at operation 124. If new jobs or updated jobs (e.g., jobs that need to be reviewed) are located at operation 126, the new or updated job(s) may be downloaded and unpacked by the engineer at operation 128. Once the job(s) are unpacked, or even if there are no new or updated jobs, but a job is selected by the engineer for review, the engineer may review the corresponding drawings, stamp them (e.g., using the sealing and signature mechanism described above) or provide comments on the drawings at operation 130. FIG. 5 illustrates an exemplary display of a job selection screen via which selection of a particular job may be accomplished or various tasks may be performed. A determination may be made at operation 132 as to whether the job review is complete. If the job review is complete, the job files may uploaded to the data processing center at operation 134. However, if the job review is not complete, the job may be returned to the engineer for completion of the review. Once files have been uploaded to the data processing center with review completed (or if the job was previously reviewed), job files may be unpacked, processed and posted at operation 136. The customer may then be notified at operation 138. Of note, if a particular document is updated and is therefore resealed and resigned, the updated document may also be made available via the same URL that was used to access to original or parent document. A history of changes to the document may be indicated at the URL so that an individual may easily determine whether changes were made to the document the individual currently has, or whether such document is the most recent version. As such, any individual typing in the access restricted URL will be able to view not only the parent document, but each child document in order to find the most recent or current version. As such, the document history may indicate that the update occurred and may further indicate the nature of the update or provide access to prior document versions.

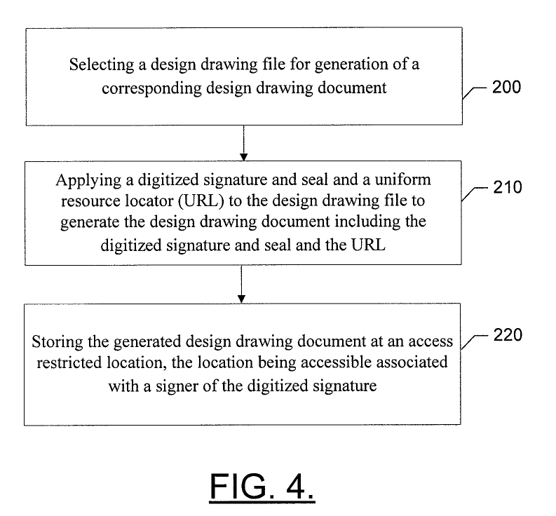

FIG. 4 is a flowchart of a system, method and computer program product according to an exemplary embodiment of the invention. It will be understood that each block or step of the flowchart (and the diagram of FIG. 3), and combinations of blocks in the flowchart, can be implemented by various means, such as one or more of hardware, firmware, or software including one or more computer program instructions. For example, one or more of the procedures described above may be embodied by computer program instructions. In this regard, the computer program instructions which embody the procedures described above may be stored by a memory device of, for example, the terminal or server and executed by its respective processing element 26. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

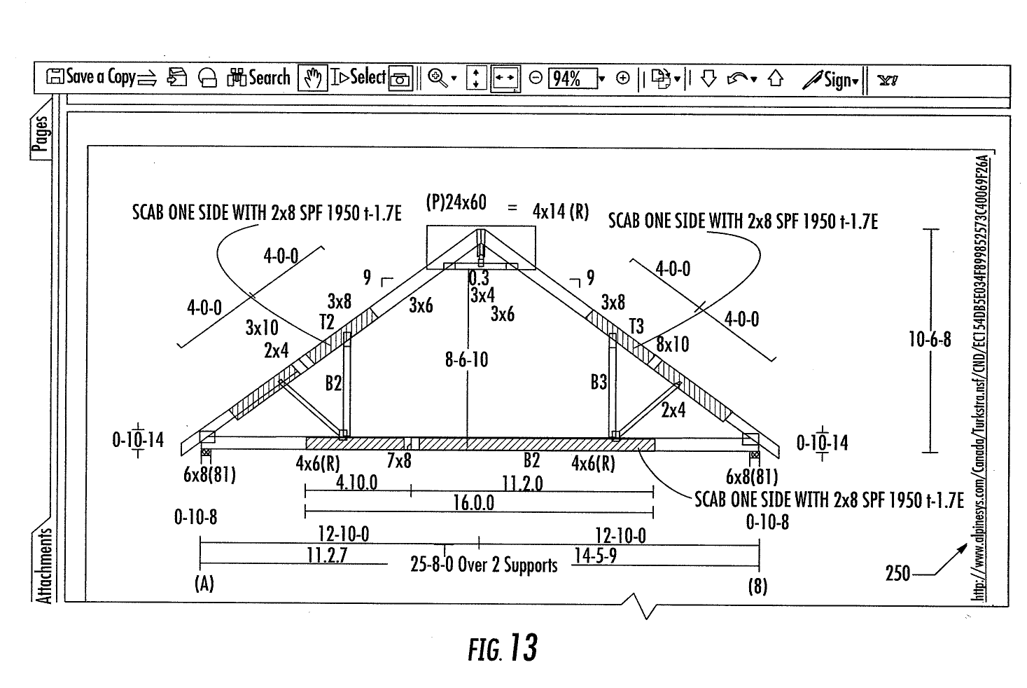

In this regard, one embodiment of a method of enabling secure control over electronic seals and signatures, as shown in FIG. 4, may include selecting a design drawing file for generation of a corresponding design drawing document at operation 200. At operation 210, a digitized signature and seal and a URL may be applied to the design drawing file to generate the design drawing document including the digitized signature and seal and the URL (e.g., see URL 250 on FIG. 13). The generated design drawing document may then be stored at a location accessible via the URL at operation 220. The URL may point to an access restricted location associated with a signer of the digitized signature.

In an exemplary embodiment, the method may include additional operations. For example, the method may further include operations of receiving input corresponding to the design drawing file from an external source and providing the input on an overlay associated with the design drawing file. In this regard, receiving the input may include receiving changes, comments or approval of the design drawing file. In an alternative embodiment, an additional operation of generating a document history indicative of changes made with respect to the design drawing file may be included. The document history may be accessible via the URL. In some embodiments, the method may also include certifying the digital signature and seal in accordance with a certificate authority or obtaining a certification from an external source for inclusion on the design drawing document. In this regard, the certification may be obtained in response to completion of an internal document certification.

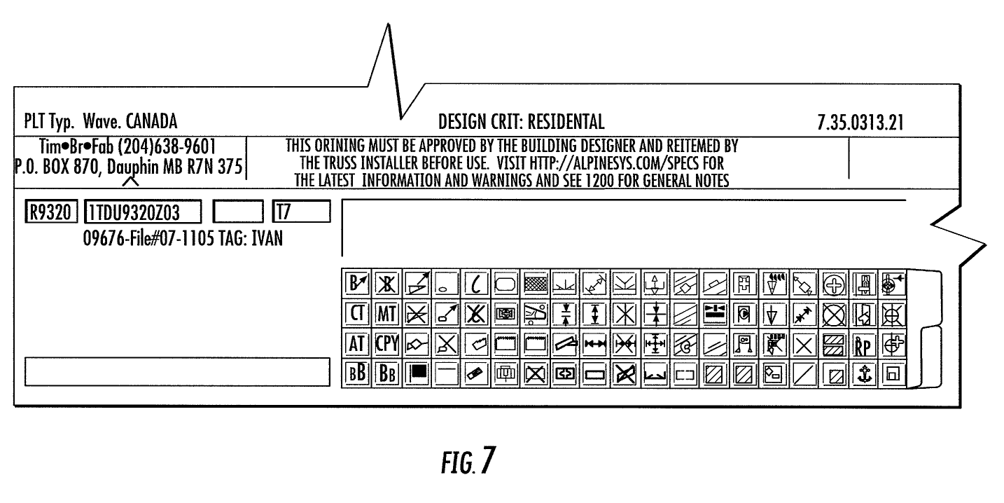

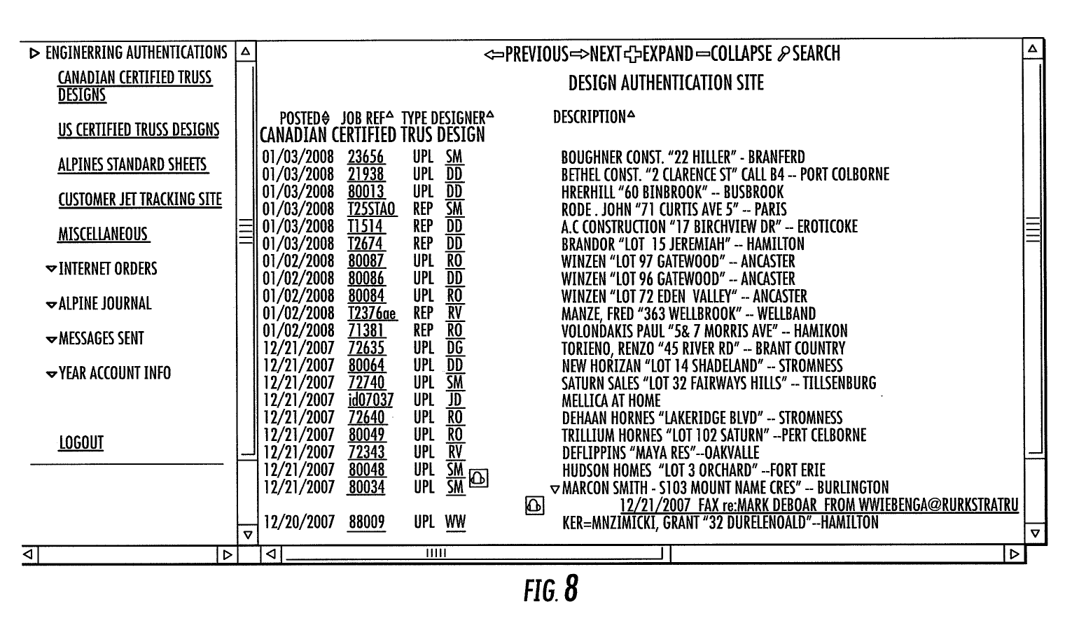

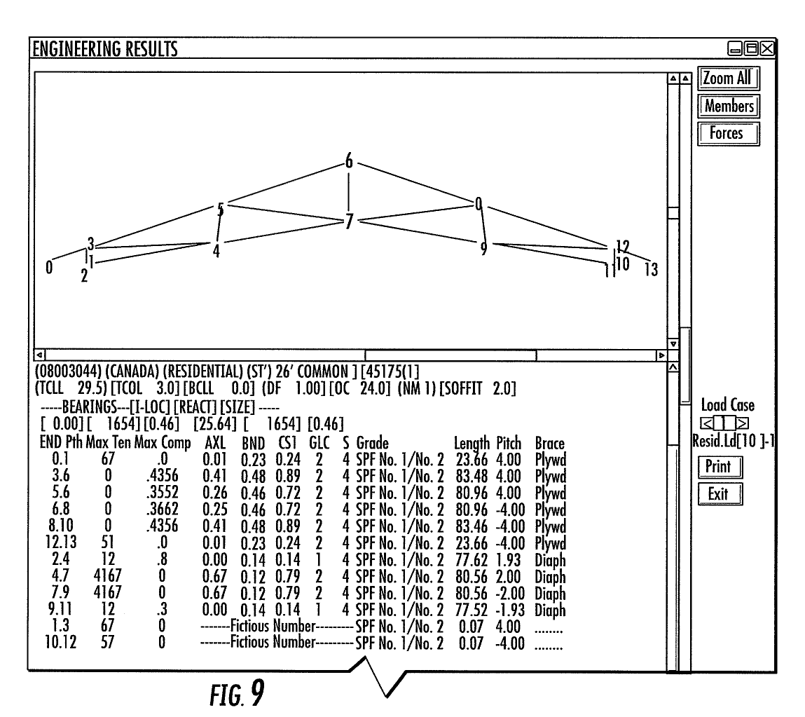

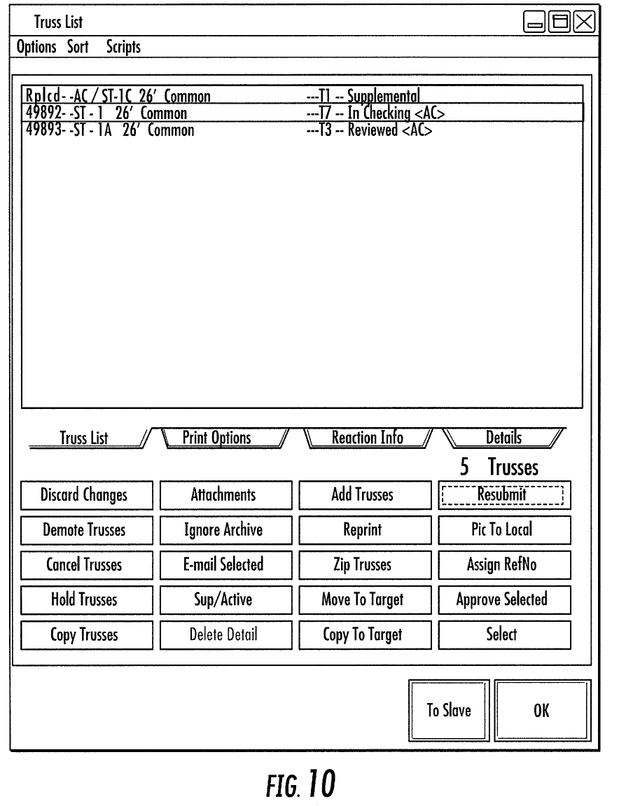

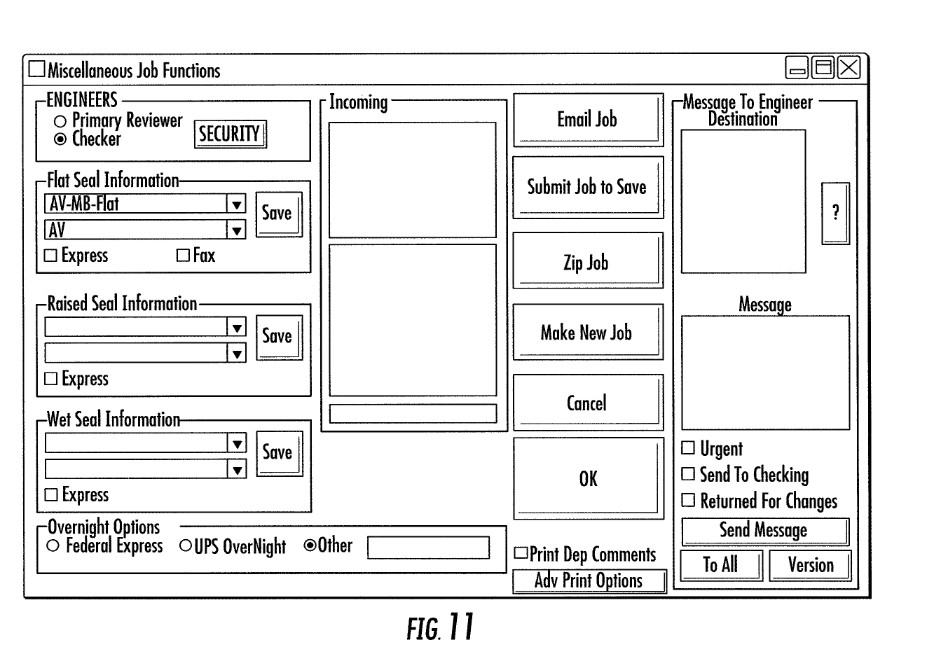

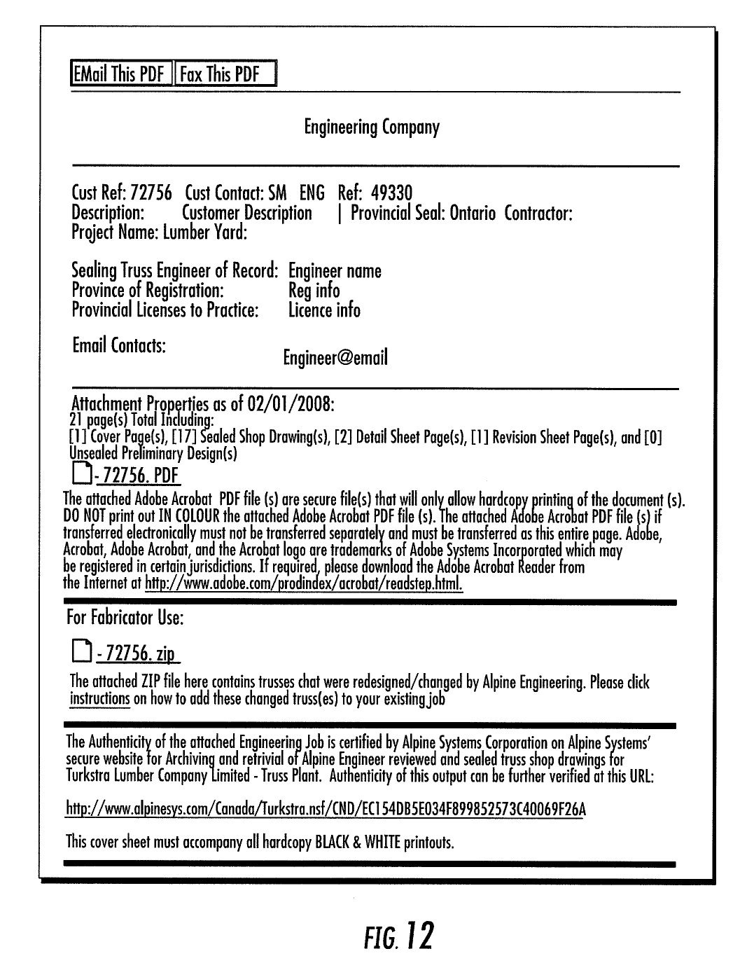

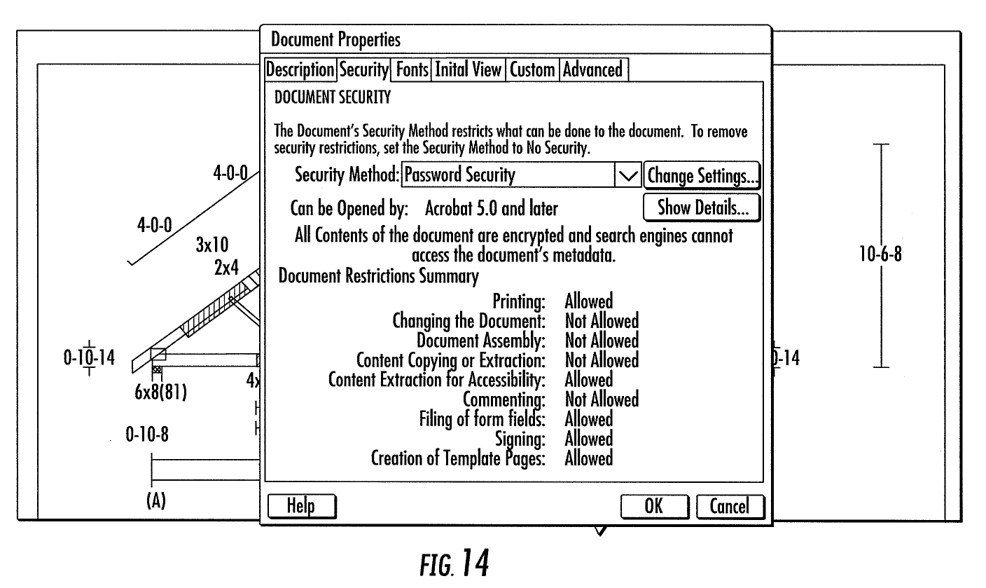

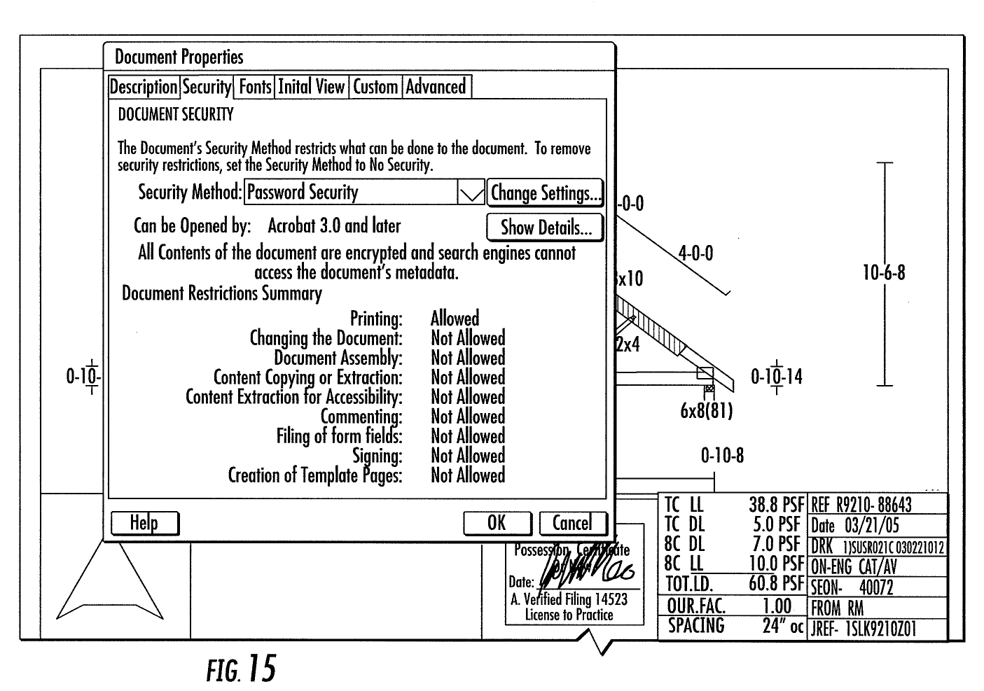

FIGS. 5-14 illustrate various screenshots or examples of user interface screens and options that may be encountered in an authentication website hosted by the data processing center 18 in accordance with an exemplary embodiment of the present invention. In this regard, for example, FIG. 14 illustrates an intermediate security setting and FIG. 15 illustrates a security setting that may be visible at a customer terminal.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

That which is claimed:

1. A method comprising:
applying a digitized signature and seal and a uniform resource locator (URL) to a design drawing file to generate a design drawing document including the digitized signature and seal and the URL; and
storing the generated design drawing document at an access-restricted location accessible via the URL, the location being associated with a signer of the digitized signature.

2. The method of claim 1, further comprising receiving input corresponding to the design drawing file from an external source and providing the input on an overlay associated with the design drawing file.

3. The method of claim 2, wherein receiving input comprises receiving changes, comments or approval of the design drawing file.

4. The method of claim 1, further comprising generating a document history indicative of changes made with respect to the design drawing file, the document history being accessible via the URL.

5. The method of claim 1, wherein applying the digitized signature and seal comprises positioning the digitized signature and seal independently of one another within a predefined area.

6. The method of claim 1, further comprising certifying the digitized signature and seal in accordance with a certificate authority.

7. The method of claim 1, further comprising obtaining a certification from an external source for inclusion on the design drawing document, the certification being obtained in response to completion of an internal document certification.

8. A computer program product comprising at least one computer-readable storage medium having computer-readable program code portions stored therein, the computer-readable program code portions comprising:
a first executable portion for applying a digitized signature and seal and a uniform resource locator (URL) to a design drawing file to generate a design drawing document including the digitized signature and seal and the URL; and
a second executable portion for storing the generated design drawing document at an access-restricted location accessible via the URL, the location being associated with a signer of the digitized signature.

9. The computer program product of claim 8, further comprising a third executable portion for receiving input corresponding to the design drawing file from an external source and providing the input on an overlay associated with the design drawing file.

10. The computer program product of claim 9, wherein the third executable portion includes instructions for receiving changes, comments or approval of the design drawing file.

11. The computer program product of claim 8, further comprising a third executable portion for generating a document history indicative of changes made with respect to the design drawing file, the document history being accessible via the URL.

12. The computer program product of claim 8, wherein the first executable portion includes instructions for positioning the digitized signature and seal independently of one another within a predefined area.

13. The computer program product of claim 8, further comprising a third executable portion for certifying the digitized signature and seal in accordance with a certificate authority.

14. The computer program product of claim 8, further comprising a third executable portion for obtaining a certification from an external source for inclusion on the design drawing document, the certification being obtained in response to completion of an internal document certification.

15. An apparatus comprising a processing element configured to:
apply a digitized signature and seal and a uniform resource locator (URL) to a design drawing file to generate a design drawing document including the digitized signature and seal and the URL; and
store the generated design drawing document at an access-restricted location accessible via the URL, the location being associated with a signer of the digitized signature.

16. The apparatus of claim 15, wherein the processing element is further configured to receive input corresponding to the design drawing file from an external source and provide the input on an overlay associated with the design drawing file.

17. The apparatus of claim 16, wherein the processing element is further configured to receive input comprising a change, a comment or approval of the design drawing file.

18. The apparatus of claim 15, wherein the processing element is further configured to generate a document history indicative of changes made with respect to the design drawing file, the document history being accessible via the URL.

19. The apparatus of claim 15, wherein the processing element is further configured to apply the digitized signature and seal by positioning the digitized signature and seal independently of one another within a predefined area.

20. The apparatus of claim 15, wherein the processing element is further configured to certify the digitized signature and seal in accordance with a certificate authority.

21. The apparatus of claim 15, wherein the processing element is further configured to obtain a certification from an external source for inclusion on the design drawing document, the certification being obtained in response to completion of an internal document certification.
